(19) United States
(12) Patent Application Publication
(10) Pub. No.: US 2021/0166176 A1
(43) Pub. Date: Jun. 3, 2021

(54) Information Perception Method Based on an Operation and Maintenance Scene Knowledge Base

(71) Applicant: Shanghai Data Center Science Co., Ltd., Shanghai (CN)

(72) Inventor: Jun Zhang, Shanghai (CN)

(73) Assignee: Shanghai Data Center Science Co., Ltd., Shanghai (CN)

(21) Appl. No.: 16/648,278

(22) PCT Filed: May 14, 2019
(86) PCT No.: PCT/CN2019/086749

§ 371 Date: Mar. 18, 2020

(30) Foreign Application Priority Data
May 10, 2019 (CN) 201910390575.1

(51) Int. Cl. G06Q 10/06; G06N 5/02; G06Q 10/00

(52) U.S. Cl. CPC G06Q 10/06315; G06Q 10/20; G06Q 10/0635; G06N 5/025

(57) ABSTRACT

Provided is an information perception method based on an operation and maintenance scene knowledge base. An information node monitor is in charge of monitoring updates of a distribution information node and stored context information. A context retriever is in charge of indexing and retrieving the stored context information. An interpreter is used for providing services for the information node monitor and the context retriever. When the context is retrieved and found out to be changed, a rule engine is used for self-adaptive management and deducing a high-level context according to a rule body in the operation and maintenance scene knowledge base. The deduced high-level context is sent to a uniform service management software platform.

### TECHNICAL FIELD

The present disclosure relates to the technical field of cloud computing and, in particular, to an information perception method based on an operation and maintenance scene knowledge base.

### BACKGROUND

At present, with the characteristics of large scale, high density, high energy consumption, complexity and the like presented by cloud computing and virtualization, the building and development of a new generation of data center, and the improvement of infrastructure management of the data center become increasingly important. Infrastructure fusion management and intelligence of the data center become a new trend of the development of the data center. Data may be stored in a hosting data center. The hosting managed data center not only provides management services, but also provides servers and storage services for users. The users may use the storage space and the computing environment provided by the data center without purchasing equipment by themselves. An operation and maintenance scene of the data center includes infrastructure exceptions, computer hardware exceptions, system exceptions, application system exceptions, redundancy mechanism failures, data exceptions, and information security.

Therefore, how to promote the infrastructure management of the data center, and the infrastructure fusion management and intelligence management of the data center are urgent problems that need to be solved by those skilled in the art.

### SUMMARY

In view of this, the present disclosure provides an information perception method based on an operation and maintenance scene knowledge base. An information node monitor is in charge of monitoring updates from a distribution information node and stored context information. A context retriever is in charge of indexing and retrieving the stored context information. An interpreter is used for providing services for the information node monitor and the context retriever. When the context is retrieved and found out to be changed, a rule engine is used for adaptive management and deducing a high-level context according to a rule body in the operation and maintenance scene knowledge base. The deduced high-level context is sent to a uniform service management software platform, so as to implement automatic early warning and precaution of accidents.

To achieve the preceding objects, the present disclosure provides the technical scheme described below.

An information perception method based on an operation and maintenance scene knowledge base includes steps described below.

A distribution information node collects various device data information, and sends the collected information through a communication interface.

An information node monitor monitors, through an interpreter, updates of the collected information from the distribution information node and context information stored in the operation and maintenance scene knowledge base.

A context retriever indexes and retrieves, through the interpreter, the context information stored in the operation and maintenance knowledge base.

When the context information is retrieved and found out to be changed, self-adaptive management is performed through a rule engine.

The operation and maintenance environment knowledge base deduces a high-level context according to an operation and maintenance body.

The deduced high-level context is sent to a service management software platform.

Preferably, the information node monitor includes a communication component. The communication component communicates with the communication interface of the distribution information node.

Preferably, the information node includes a camera and a sensor.

Preferably, the method further includes a following step: a hierarchical structure is configured for avoiding lower-level perception details and providing a necessary context perception service for an application.

According to the preceding technical scheme, compared with the existing art, the present disclosure discloses and provides the information perception method based on the operation and maintenance scene knowledge base. In an operation and maintenance scene, monitoring information and updating information of the knowledge base are obtained through information of monitoring equipment or environment, context information is obtained, self-adaptive management is performed by the rule engine, the high-level context is deduced according to the context information through a rule body, and context perception services are provided through a uniform service management software platform, so as to implement automatic early warning and precaution of accidents. Relevant services are provided according to the user task and the deducing of the context information.

### BRIEF DESCRIPTION OF DRAWINGS

To illustrate the technical scheme in the embodiment of the present disclosure or the technical scheme in the existing art more clearly, a drawing used in the description of the embodiment or the existing art will be briefly described below. Apparently, the drawing described below is merely the embodiment of the present disclosure, and those skilled in the art may obtain other drawings based on the provided drawing on the premise that no creative work is done.

FIG. 1 is a schematic structural view of an information perception method based on an operation and maintenance scene knowledge base according to the present disclosure.

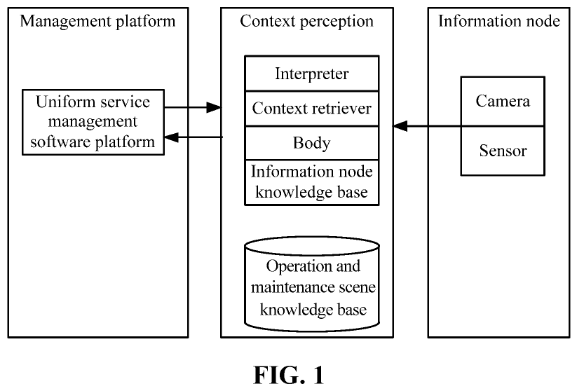

### DETAILED DESCRIPTION

The technical scheme in the embodiment of the present disclosure will be described clearly and completely in connection with the drawing in the embodiment of the present disclosure. Apparently, the embodiment described is part, not all, of the embodiments of the present disclosure. Based on the embodiment of the present disclosure, all other embodiments obtained by those skilled in the art without creative work are within the scope of the present disclosure.

The embodiment of the present disclosure discloses an information perception method based on an operation and maintenance scene knowledge base, which includes the steps described below.

A distribution information node collects various device data information and sends the collected information through a communication interface.

An information node monitor monitors, through an interpreter, updates of the collected information from the distribution information node and context information stored in the operation and maintenance scene knowledge base.

A context retriever indexes and retrieves, through the interpreter, the context information stored in the operation and maintenance knowledge base.

When the context information is retrieved and found out to be changed, self-adaptive management is performed through a rule engine.

The operation and maintenance environment knowledge base deduces a high-level context according to an operation and maintenance body.

The deduced high-level context is sent to a service management software platform.

To further optimize the preceding technical scheme, the information node monitor includes a communication component. The communication component communicates with the communication interface of the distribution information node.

To further optimize the preceding technical scheme, the information node includes a camera and a sensor.

To further optimize the preceding technical scheme, the method further includes a following step: a hierarchical structure is configured for avoiding lower-level perception details and providing a necessary context perception service for an application.

### EMBODIMENT

An operation and maintenance scene includes infrastructure exceptions, computer hardware exceptions, system exceptions, application system exceptions, redundancy mechanism failures, data exceptions, and information security.

A concept of a knowledge base comes from two different fields, one is the field of artificial intelligence and its branch-knowledge engineering, and the other is the field of traditional database. The organic combination of two computer technologies (artificial intelligence and database) promotes the emergence and development of a knowledge base system. Lack of automation means, passive operation and maintenance, low efficiency, and large-scale information technology (IT) facilities bring management pressure. When sensors and other methods are used for perceiving information, a uniform service management software platform can be implemented.

Pervasive computing refers to ubiquitous computing. Context perception computing has become a core research topic in a pervasive computing project. A context is a kind of information that may be used for describing the situation of an entity. The entity may be a person, a place, or an object that is considered to interact with a user and an application. The entity includes the user and the application. If whether a system involves context perception depends on whether the system provides users with relevant information and services according to context information, then the correlation depends on users' tasks.

In a pervasive computing environment, the system has to perceive dynamically changing context information and take corresponding actions. Therefore, in order to meet these requirements, it is necessary to separate perception from application development, that is, to separate lower-level perception data processing from higher-level context perception applications. A layering structure is adopted for context perception to avoid lower-level perception details and provides a necessary context perception service for an application.

A body is a consensus of sharable concepts, giving the same understanding from expression to actual semantic connotation. These concepts include a variety of conceptual frameworks used in model construction for knowledge in different application domains and stipulation of application-related communication rules.

Embodiments in this specification are described in a progressive manner. Each embodiment focuses on differences from other embodiments. The same or similar parts in the embodiments can be referred to by each other. As for the device disclosed in the embodiment, since corresponding to the method disclosed in the embodiment, description of the device is relatively simple, and the relevant part may refer to the description of the method.

The above description of the disclosed embodiments enables those skilled in the art to implement or use the present disclosure. Various modifications to these embodiments will be apparent to those skilled in the art, and the general principles defined herein may be implemented in other embodiments without departing from the spirit or scope of the present disclosure. Therefore, the present disclosure is not limited to the embodiments shown herein but conforms to the widest scope consistent with the principles and new features disclosed herein.

1. An information perception method based on an operation and maintenance scene knowledge base, comprising:
collecting, by a distribution information node, various device data information, and sending the collected information through a communication interface;
monitoring, by an information node monitor and through an interpreter, the collected information from the distribution information node and context information stored in the operation and maintenance scene knowledge base;
in a case where the context information changes, updating the context information;
indexing and retrieving, by a context retriever and through the interpreter, the updated context information stored in the operation and maintenance scene knowledge base;
in a case where the updated context information is retrieved and found out to be changed, performing self-adaptive management through a rule engine;
deducing, by the operation and maintenance scene knowledge base, a high-level context according to an operation and maintenance body; and
sending the deduced high-level context to a service management software platform.

2. The method of claim 1, wherein the information node monitor comprises a communication component, and the communication component communicates with the communication interface of the distribution information node.

3. The method of claim 1, wherein the information node comprises a camera and a sensor.

4. The method of claim 1, further comprising:
configuring a hierarchical structure for avoiding lower-level perception details and providing a necessary context perception service for an application.
